(19) United States
(12) Patent Application Publication
(10) Pub. No.: US 2025/0183955 A1
(43) Pub. Date: Jun. 5, 2025

(54) CONTROL METHOD AND ELECTRONIC DEVICE

(71) Applicant: Lenovo (Beijing) Limited, Beijing (CN)

(72) Inventors: Zhaobin LIN, Beijing (CN); Yu-Che LIN, Beijing (CN)

(21) Appl. No.: 18/954,014

(22) Filed: Nov. 20, 2024

(30) Foreign Application Priority Data
Nov. 30, 2023 (CN) 202311635490.8

(51) Int. Cl. H04B 7/06; H04B 7/0456; H04W 52/06

(52) U.S. Cl. CPC H04B 7/0602; H04B 7/0465; H04W 52/06

(57) ABSTRACT

The control method includes determining a target operating mode in response to a target instruction in a target scenario, controlling a target antenna in the target operating mode to receive a first radiated signal at a first frequency, and transmitting a second radiated signal at a second frequency. The first frequency and the second frequency belong to a same frequency band. The target operating mode includes a plurality of different antenna operating modes. Under at least two of the antenna operating modes of the plurality of different antenna operating modes, the second radiated signal at the second frequency is transmitted at different target powers to cause transmission powers of the plurality of different operating modes to be equal to or approach a power limit of the target scenario. The target power represents a power of a radio frequency path between an antenna port of the target antenna and a transceiver.

### CROSS-REFERENCE TO RELATED APPLICATION

This application claims priority to Chinese Patent Application No. 202311635490.8, filed on Nov. 30, 2023, and the entire content of which is incorporated herein by reference.

### TECHNICAL FIELD

The present disclosure relates to the technology of controlling antenna radiation and, more particularly, to a control method and an electronic device.

### BACKGROUND

Currently, regardless of the operating mode, an antenna of electronic devices transmits signals at the same power via a power amplifier. Thus, the antenna is not able to adapt to the operating scenario for signal transmission. In some operating scenarios of the antenna, since the power amplifier transmits a radiated signal at the same power, the performance of radiated signal of the antenna is degraded. As a result, the base station is difficult to demodulate the signal, which affects the throughput rate of the electronic device, leads to a decrease in the throughput of the electronic device, or even causes the device disconnected from the network.

### SUMMARY

One aspect of the present disclosure provides a control method. The control method includes determining a target operating mode in response to a target instruction in a target scenario, controlling a target antenna in the target operating mode to receive a first radiated signal at a first frequency and transmit a second radiated signal at a second frequency. The first frequency and the second frequency belongs to a same frequency band. The target operating mode includes a plurality of different antenna operating modes. Under at least two of the antenna operating modes of the plurality of different antenna operating modes, the second radiated signal at the second frequency is transmitted at different target powers to cause transmission powers of the plurality of different operating modes to be equal to or approach a power limit of the target scenario. The target power represents a power of a radio frequency path between an antenna port of the target antenna and a transceiver.

Another aspect of the present disclosure provides an electronic device, including a processor and an antenna adjustment module. The processor is configured to determine a target operating mode in response to a target instruction in a target scenario. The antenna adjustment module is communicatively connected to the processor and configured to control a target antenna in the target operating mode to receive a first radiated signal at a first frequency and transmit a second radiated signal at a second frequency. The first frequency and the second frequency belong to a same frequency band. The target operating mode includes a plurality of different antenna operating modes. Under at least two of the antenna operating modes of the plurality of different antenna operating modes, the second radiated signal at the second frequency is transmitted at different target powers to cause transmission powers of the plurality of different operating modes to be equal to or approach a power limit of the target scenario. The target power represents a power of a radio frequency path between an antenna port of the target antenna and a transceiver.

Another aspect of the present disclosure provides a computer readable storage medium storing a computer program that, when executed by one or more processors, causes the one or more processors to determine a target operating mode in response to a target instruction in a target scenario, control a target antenna in the target operating mode to receive a first radiated signal at a first frequency and transmit a second radiated signal at a second frequency. The first frequency and the second frequency belong to a same frequency band. The target operating mode includes a plurality of different antenna operating modes. Under at least two of the antenna operating modes of the plurality of different antenna operating modes, the second radiated signal at the second frequency is transmitted at different target powers to cause transmission powers of the plurality of different operating modes to be equal to or approach a power limit of the target scenario. The target power represents a power of a radio frequency path between an antenna port of the target antenna and a transceiver.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a first flowchart of the control method of an embodiment of the present disclosure;

FIG. 2 shows the first configuration table in the case where the target scenario contains an electromagnetic radiation-limited object in the present disclosure;

FIG. 3 shows the second configuration table in the case where the target scenario contains a non-limited electromagnetic radiation object in the present disclosure;

FIG. 4 shows the third configuration table in the case where the target scenario contains an electromagnetic radiation-limited object in prior art;

FIG. 5 is a second flowchart of the control method of another embodiment of the present disclosure;

FIG. 6 is a block diagram of the electronic device provided by the present disclosure.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

The present disclosure provides a control method. The control method can be applied to an electronic device to control the radiation performance of an antenna. The electronic device can be various electronic devices, such as a smartphone, a tablet, or a laptop, etc. The present disclosure shall not limit the type of the electronic device, as long as the electronic device has a target antenna 302.

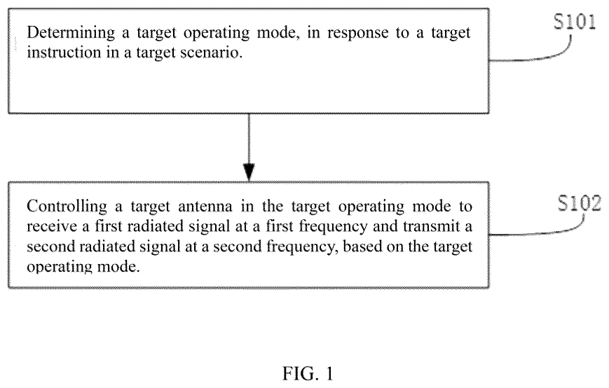

As shown in FIG. 1, the control method includes steps S101 and S102.

At S101, determining a target operating mode, in response to a target instruction in a target scenario.

In some embodiments of the present disclosure, the target scenario can be understood as the scenario where the target antenna 302 is currently in. The target scenario can be related to the radiation performance and reception performance of the target antenna 302.

In an embodiment, when radiation performance and reception performance of the target antenna 302 are relatively balanced, it can be determined that the electronic device is in a first target scenario. In this case, the electronic device can generate a first target instruction. When the radiation performance of the target antenna 302 is degraded, it can be determined that the electronic device is in a second target scenario. In this case, the electronic device can generate a second target instruction. When the reception performance of the target antenna 302 is degraded, the electronic device can be determined to be in a third target scenario. In this case, the electronic device can generate a third target instruction.

As a consequence, the scenario of the target antenna 302, can be directly determined, based on the radiation performance and reception performance of the target antenna 302. Moreover, based on the determination of the scenario, commands can be generated to determine the target operating mode of the target antenna 302, which is configured to adapt to the current scenario.

At S102, the embodiment in the target operating mode, controls the target antenna 302 to receive a first radiated signal at a first frequency, while transmitting a second radiated signal at a second frequency. The first frequency and the second frequency are at a same frequency band. The target operating mode includes multiple different antenna operating modes. Among the multiple different antenna operating modes, there are at least two different antenna operating modes, transmitting the second radiated signal at the second frequency, with different target power. The target power is used to characterize the power of the radio frequency path between the antenna port of the target antenna 302 and the transceiver 202, enabling that the transmission power in different antenna operating modes either equals or approaches a power limit of the target scenario.

In some embodiments of the present disclosure, the target power can be understood as a conducted target power of the antenna. The transmission power of the antenna is a summation of the conducted target power and a radiation gain. By modifying the conducted target power, the transmission power of the antenna can be adjusted. which achieves the purpose of adjusting the radiation performance of the antenna.

In some embodiments of the present disclosure, the control method is applied to an electronic device, which includes a power amplifier 203. The target power can be understood as a limit power in operation of the power amplifier 203. This means that the power amplifier 203 shall operate at a power no greater than the target power. The power amplifier is able to increase signal gain to a high power level, without compromising signal quality. In the present disclosure, in different antenna operating modes, the target power of the power amplifier 203 is different. This allows in different antenna operating modes, the maximum transmission power of the power amplifier 203 can be equal to or approach the power limit of the target scenario. As a result, the transmission power of the antenna can be maximized, and the radiation performance of the antenna can be increased efficiently.

In some embodiments of the present disclosure, the target scenario may at least include an electromagnetic radiation-limited object and a non-limited electromagnetic radiation object. For example, if the target scenario in which the electronic device is located includes objects such as a human body, which cannot absorb excessive electromagnetic radiation energy, then it can be determined that the target scenario contains an electromagnetic radiation-limited object.

The corresponding power limit for the target scenario can be determined in the target scenario, which contains an electromagnetic radiation-limited object. The power limit can be understood as the Specific Absorption Rate (SAR). SAR is a parameter used to measure the amount of electromagnetic radiation energy absorbed by human body. When the electronic device is close to the human body, the transmission power of the second radiated signal from the device must not exceed the SAR, which means that it must not exceed the power limit, in order to protect the human body.

In some embodiments of the present disclosure, the transmission power in different antenna operating modes either equals or approaches the power limit of the target scenario. This can be understood as the transmission power of the antenna shall be less than or equal to the power limit of the target scenario, to avoid the issue of excessive radiation.

In some embodiments of the present disclosure, a configuration table can be set for the antenna operating modes in different target scenarios. The configuration table can be stored in a processor 101 of the electronic device, and the processor 101 can call the configuration table while determining the antenna operating mode. There can be multiple configuration tables, allowing the determination of the transmission performance parameters and reception performance parameters of the target antenna 302, in different antenna operating modes, under different target scenarios.

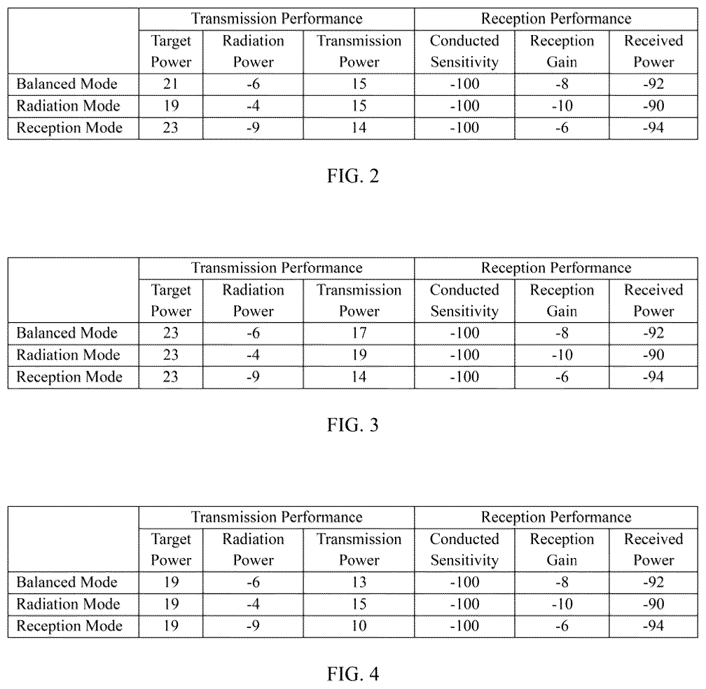

In an embodiment, a first configuration table is shown in FIG. 2, where the target scenario contains an electromagnetic radiation-limited object. In this case, the first configuration table has the power limit for the scenario at 15 dBm. This means that regardless of the antenna operating mode of the target antenna 302, its transmission power must not exceed 15 dBm. As illustrated in FIG. 2, it can be determined that the target power in different antenna operating modes is different. Accordingly, the transmission power in different antenna operating modes is also different, and shall never exceed 15 dBm. This ensures compliance with the protection requirements for electromagnetic radiation-limited objects and prevents the occurrence of excessive radiation.

Moreover, as shown in FIG. 2, conducted sensitivity can be understood as an operating parameter of a low-noise amplifier 204. The reception power is a summation of the conducted sensitivity and the reception gain. The reception power in reception mode is greater than the reception power in balanced mode and radiation mode. The reception performance of the antenna in the reception mode can be optimized. The stability of the antenna can be increased while receiving the first radiated signal.

In an embodiment of the present disclosure, a second configuration table is shown in FIG. 3, where the target scenario contains a non-limited electromagnetic radiation object. In this case, the target scenario does not contain an electromagnetic radiation-limited object. For instance, the electronic device is not close to a human body, but placed on a desk. The scenario corresponding to the second configuration table, has no power limit. The target power can be modified to its maximum value, to maximize the radiation performance. In FIG. 3, the up limit of the target power is 23 dBm, which can be used to determine the transmission power in different antenna operating modes.

The parameters in the first and second configuration tables above are merely exemplary, and shall not be specifically limited in the present disclosure. The parameters in the configuration tables can vary based on changes in some attributes of the antenna. In the present disclosure, the values in the tables are solely for illustrative purposes. For instance, the radiation gain measures the ability to transmit signals of the antenna, in a specific direction, while the reception gain measures the ability to receive signals of the antenna in a specific direction. The radiation gain and reception gain are not affected by whether the target scenario contains an electromagnetic radiation-limited object.

As shown in FIG. 4, it illustrates a third configuration table from the prior art, where the target scenario contains an electromagnetic radiation-limited object. In the third configuration table, the target power for all antenna operating modes is the same. This is achieved by reducing the target power of the power amplifier 203 to a same value and then determining the transmission power for different antenna operating modes. More specifically, the transmission power for each antenna operating mode is determined after reducing the target power to 19 dBm. Note that, in reception mode, the transmission power even drops to 10 dBm, which is far below the power limit of 15 dBm. Although this satisfies the protection requirements for electromagnetic radiation-limited objects, the excessively low transmission power causes a degradation in the radiated signal performance. This makes the base station difficult to demodulate the signal. As a result, it negatively affects the throughput rate of the electronic device, and leads to a decrease in throughput of the electronic device, or even causes the device disconnected from the network.

Comparing the first configuration table with the third configuration table, it can be seen that, compared to the prior art, the control method provided in the present disclosure allows for adjusting the target power in the balanced mode to 21 dBm, and the transmission power to 15 dBm, and adjusting the target power in the reception mode up to 23 dBm and in the transmission power to 14 dBm. In contrast, in the prior art, the transmission power in balanced mode is 13 dBm, and in reception mode, it is 10 dBm. In the present disclosure, performance can be improved by configuring different target power for different antenna operating modes to transmit the second radiated signal at the second frequency. the transmission power in different antenna operating modes can be ensured to either equal or approach the power limit of the target scenario, maximizing the radiation performance in each mode. As a result, the electronic device comprising the antenna can maintain stable communication with the base station.

The present disclosure provides a control method, which is capable of determining the target operating mode of the target antenna 302 based on the target instructions generated for the current scenario. The target antenna 302 can be caused to receive the first radiated signal and transmit the second radiated signal according to the target operating mode. In this case, the target operating modes include multiple different antenna operating modes, and under at least two of the antenna operating modes, the second radiated signal at the second frequency is transmitted at different target power. As a result, the target antenna 302 is able to transmit the second radiated signal based on the current scenario. This solution addresses the issue in the prior art where the power amplifier 203 transmits radiated signals at a same power level, unable to adaptively adjust the target power for transmitting the second radiated signal at the second frequency based on the scenario. This approach improves the radiation performance of the antenna, and ensures stable signal transmission to the base station.

In some embodiments of the present disclosure, different target scenarios correspond to different target operating modes, and different target scenarios correspond to different power limits.

In embodiments of the present disclosure, by determining the corresponding target operating mode and/or power limit for each scenario, the adaptability between the target scenario and the operating mode and/or power limit can be enhanced. As a result, the transmission power of the antenna can be maximized in each target scenario, and the radiation performance of the antenna con be improved.

In some embodiments of the present disclosure, the target operating modes may include: balanced mode, radiation mode, and reception mode. In scenarios where the target contains an electromagnetic radiation-limited object, the target power in different antenna operating modes is different. Consequently, the transmission power in different antenna operating modes is also different.

In an embodiment, as shown in FIG. 2, in the case where the target scenario contains an electromagnetic radiation-limited object, when the target operating mode is determined to be the balanced mode, the antenna can transmit the second radiated signal at the second frequency with a target power of 21 dBm; when the target operating mode is determined to be the radiation mode, the antenna can transmit the second radiated signal at the second frequency with a target power of 19 dBm; and when the target operating mode is determined to be the reception mode, the antenna can transmit the second radiated signal at the second frequency with a target power of 23 dBm.

In some embodiments of the present disclosure, different power limits can be associated with different electromagnetic radiation-limited objects in different target scenarios. Different power limits can be set for different radiation-limited objects to ensure the protection.

In an embodiment, when the electromagnetic radiation-limited object in the target scenario is a human head, the corresponding power limit can be determined as a first power limit, such as 15 dBm. When the electromagnetic radiation-limited object in the target scenario is a human hand, the corresponding power limit can be determined as a second power limit, which is different from the first power limit.

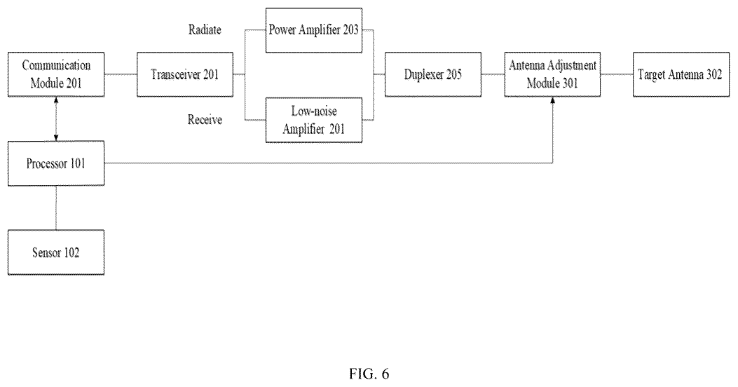

In some embodiments of the present disclosure, as shown in FIG. 6, the electronic device may include a sensor 102, which is connected with communication to the processor 101. The sensor 102 can detect the scenario where the electronic device is in, to determine the power limit. For example, the electronic device can use sensor 102 to detect its proximity to the human head, thereby determining that the power limit is the first power limit. The processor 101 can then determine the antenna operating mode based on the first configuration table.

In some embodiments of the present disclosure, different configuration tables can be configured for different power limits. For example, the first configuration table shown in FIG. 2 is the configuration table corresponding to the human head, with a power limit of 15 dBm. For other power limits, additional configuration tables can be provided to adjust the target power, which ensures that the transmission power in different antenna operating modes either equals or approaches the power limit of the target scenario.

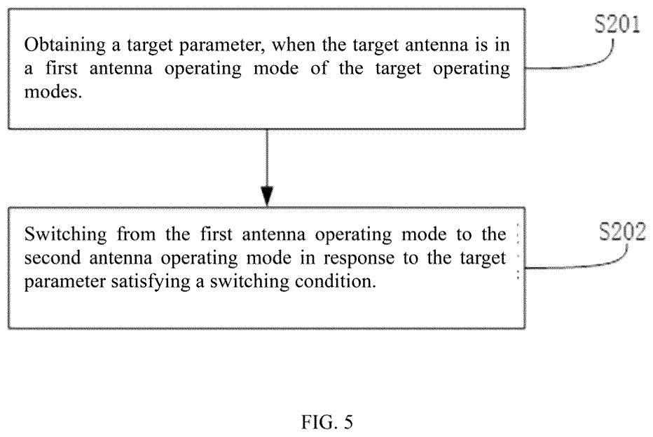

In some embodiments of the present disclosure, as shown in FIG. 5, the control method further includes steps S201 and S202.

At S201, obtaining target parameters, when the target antenna 302 is in a first antenna operating mode of the target operating modes; and

At S202, switching from the first antenna operating mode to the second antenna operating mode, based on whether the target parameters satisfy a switching condition. In this case, the first antenna operating mode transmits the second radiated signal at the second frequency with the first target power, while the second antenna operating mode transmits the second radiated signal at the second frequency with the second target power, wherein the first target power and the second target power are different.

In this case, when the target parameters satisfy the switching condition, the antenna operating mode of the target antenna 302 can be switched accurately, whichensures that the antenna operating mode of the target antenna 302 matches the current scenario, and also allows the antenna to transmit radiated signal at the target power matching the scenario. As a result, the radiation performance of the antenna can be maximized in different scenarios.

In an embodiment, the first antenna operating mode is balanced mode, and the second antenna operating mode is reception mode. When the target parameters satisfy the switching condition, the target antenna 302 can be switched from balanced mode to reception mode. In this case, the target power can be adjusted from 21 dBm to 23 dBm, whichimproves the transmission power in the reception mode. Compared to the prior art, wherein the transmission power is just 10 dBm in reception mode, this method increases the transmission power to 14 dBm. Therefore, it improves the antenna radiation performance in reception mode.

In some embodiments of the present disclosure, the target parameters may be related to the real-time scenario where the target antenna 302 is in. These target parameters can change in real time as the scenario changes. Therefore, when the scenario changes, the antenna operating mode of the target antenna 302 can be adjusted in real time by determining the changes in the target parameters. The target antenna 302 can be ensured to operate in a mode matching the current real-time scenario.

In some embodiments of the present disclosure, as shown in FIG. 6, the electronic device can also include a communication module 201, which is connected to the processor 101 with communication. The target parameters can be obtained by the communication module 201, and then the sent by the communication module 201 to the processor 101, or can be obtained by the processor 101 directly. In the present disclosure, there shall be no specifically limit of the method of acquiring the target parameters, as long as the processor 101 can obtain the target parameters, to facilitate the switching of the antenna operating mode.

In some embodiments of the present disclosure, the target parameters are parameters representing the performance of the target antenna 302 and the radio frequency path of the target antenna 302, which are generated for sending to the base station, in response to request information received from the base station.

In this case, the target parameters can represent the communication status between the base station and the target antenna 302. Based on this communication status between the base station and the target antenna 302, it can be determined whether the antenna operating mode of the target antenna 302 needs to be switched, which allows adjusting the operating mode of the antenna accurately.

In some embodiments of the present disclosure, the target parameters can represent the reception performance and/or the transmission performance of the target antenna 302. The reception performance may include situations where the reception performance of the target antenna 302 is optimal, or situations where the reception performance of the target antenna 302 is degraded. The transmission performance of the target antenna 302 may include situations where the radiated signal transmitted by the target antenna 302 satisfies the requirements of the base station, and can be successfully received by the base station, or situations where the transmitted radiated signal by the target antenna 302 does not satisfies the requirements of the base station, and cannot be successfully received by the base station.

In some embodiments of the present disclosure, the target parameters may include one or more of the following parameters: a signal-to-noise ratio (SNR) of the antenna, or a transmission power margin of the antenna.

In some embodiments of the present disclosure, the step S202, which is switching from the first antenna operating mode to the second antenna operating mode based on whether the target parameter satisfies a switching condition, includes at least one of the following steps:

If a first parameter is less than a first threshold, then switching from the first antenna operating mode to the second antenna operating mode. When the first parameter is less than the first threshold, it indicates that the reception performance of the target antenna 302 is degraded.

If a second parameter is less than a second threshold, then switching from the first antenna operating mode to the second antenna operating mode. When the second parameter is less than the second threshold, it indicates that the transmission performance of the target antenna 302 does not satisfies the requirements of the base station.

If the first parameter is less than the first threshold, and the second parameter is less than the second threshold, then switching from the first antenna operating mode to the second antenna operating mode.

In this case, the antenna operating mode of the target antenna 302 can be determined based on the first parameter and the second parameter of target parameters, which ensures that the antenna adjusts to the mode most suitable to the current scenario.

In some embodiments of the present disclosure, the first parameter may at least include the signal-to-noise ratio (SNR) of the antenna. When the signal-to-noise ratio is less than the first threshold, it indicates that the ratio of the useful signal strength to the interference signal strength received by the antenna is low, which means that the target antenna 302 may not be able to receive the first radiated signal at the first frequency effectively. In this case, the target antenna 302 can be switched from the first operating mode to the second operating mode, in order to improve the reception performance. For instance, it can be switching from the balanced mode to the reception mode or from the radiation mode to the reception mode.

In the present disclosure, it shall not be specifically limited about the first antenna operating mode, when the first parameter is less than the first threshold. It can be either the balanced mode or the radiation mode, as long as the second antenna operating mode is the reception mode and able to improve the reception performance.

In some embodiments of the present disclosure, the second parameter may at least include the transmission power margin of the antenna. When the transmission power margin is less than the second threshold, it indicates that the transmission performance of the target antenna 302 does not satisfy the requirements of the base station. In this case, the target antenna 302 may not be able to transmit the second radiated signal at the second frequency effectively. Therefore, the target antenna 302 can be switched from the first operating mode to the second operating mode, in order to improve the radiation performance of the antenna. For instance, it can be switched from the balanced mode to the radiation mode or from the reception mode to the radiation mode. In the case where the reception mode is being switched to the radiation mode, it is necessary to first determine whether the first parameter is less than the first threshold. If so, the antenna shall remain in the reception mode and not switch to the radiation mode. If not, the antenna can be switched from the reception mode to the radiation mode.

In the present disclosure, it shall not be specifically limited about the first antenna operating mode, when the first parameter is greater than or equal to the first threshold and the second parameter is less than the second threshold. It can be either the balanced mode or the reception mode, as long as the second antenna operating mode is the radiation mode, and able improve the radiation performance.

In some embodiments of the present disclosure, when the first parameter is less than the first threshold and the second parameter is less than the second threshold, it indicates that the ratio of the valuable signal strength to interference is low, and the transmission performance of the target antenna 302 does not satisfy the requirements of the base station. In this case, the antenna operating mode of the target antenna 302 can be switched from the first operating mode to the second operating mode, that improves reception performance, which is the reception mode. By using the control method of the present disclosure, the transmission power in reception mode can be increased compared to the prior art, which allows the target antenna 302, even when switched to reception mode, to transmit the second radiated signal at the second frequency with a relatively high transmission power. The issue of further degrading the radiation performance of the antenna can be prevented, after switching to reception mode. The radiation performance of the antenna can be improved effectively to enable the antenna to transmit signals to the base station more reliably.

The present disclosure also provides an electronic device. The electronic device can be different types of devices, such as a smartphone, tablet, laptop, etc. The specific type of electronic device shall not be limited in the present disclosure, as long as the device includes a target antenna 302. As shown in FIG. 6, the electronic device includes a processor 101 and an antenna adjustment module 301 for controlling the antenna. The processor 101 and antenna adjustment module 301 are connected with communication. The processor 101 is configured to determine a target operating mode in response to a target instruction in a target scenario. The antenna adjustment module is configured to control the target antenna in the target operating mode to receive a first radiated signal at a first frequency and simultaneously transmit a second radiated signal at a second frequency, wherein the first frequency and the second frequency are in a same frequency band. In this case, the target operating mode includes multiple different antenna operating modes, and under at least two of the antenna operating modes, the second radiated signal at the second frequency is transmitted at different target power levels. The target power level represents the power of a radio frequency path between an antenna port of the target antenna 302 and a transceiver 202, which enables the transmission power under different antenna operating modes either equals or approaches the power limit of the target scenario.

In some embodiments of the present disclosure, the target scenario can be understood as the scenario where the target antenna 302 is currently in. The target scenario can be related to the radiation performance and reception performance of the target antenna 302.

In some embodiments of the present disclosure, the target power can be understood as the conducted target power of the antenna. The transmission power of the antenna is a summation of the conducted target power and the radiation gain. By modifying the conducted target power, the transmission power of the antenna can be adjusted, thereby achieving the purpose of modifying the radiation performance of the antenna.

In some embodiments of the present disclosure, the antenna adjustment module 301 is used to control and adjust the target antenna 302, which enables automatic positioning and rotation of the target antenna 302 for improved signal reception.

In some embodiments of the present disclosure, as shown in FIG. 6, the electronic device may further include a radio frequency front-end module, which is connected to the antenna adjustment module 301 with communication. The radio frequency front-end module includes a power amplifier 203. The target power can be understood as a limit power in operation of the power amplifier 203, which means that the power amplifier 203 shall operate at a power no greater than the target power. The power amplifier is able to increase signal gain to a high power level, without compromising signal quality. In the present disclosure, in different antenna operating modes, the target power of the power amplifier 203 is different. Thus, in different antenna operating modes, the maximum transmission power of the power amplifier 203 can equal or approach the power limit of the target scenario. As a result, the transmission power of the antenna can be maximized, and the radiation performance of the antenna can be increased efficiently.

In some embodiments of the present disclosure, the target scenario may at least include an electromagnetic radiation-limited object and a non-limited electromagnetic radiation object. For example, if the target scenario in which the electronic device is located includes objects such as the human body, which cannot absorb excessive electromagnetic radiation energy, it can be determined that the target scenario contains an electromagnetic radiation-limited object.

For the case where the target scenario contains an electromagnetic radiation-limited object, the corresponding power limit for the target scenario can be determined in the target scenario, which contains an electromagnetic radiation-limited object. The power limit can be understood as the Specific Absorption Rate (SAR). SAR is a parameter used to measure the amount of electromagnetic radiation energy absorbed by human body. When the electronic device is close to the human body, the transmission power of the second radiated signal from the device must not exceed the SAR, which means that it must not exceed the power limit, in order to protect the human body.

In some embodiments of the present disclosure, the transmission power in different antenna operating modes either equals or approaches the power limit of the target scenario. Thus, the transmission power of the antenna shall be less than or equal to the power limit of the target scenario, to avoid the issue of excessive radiation.

In some embodiments of the present disclosure, a configuration table can be set for the antenna operating modes in different target scenarios. The configuration table can be stored in a processor 101 of the electronic device, and the processor 101 can call the configuration table when determining the antenna operating mode. There can be multiple configuration tables allowing the determination of the transmission performance parameters and reception performance parameters of the target antenna 302, in different antenna operating modes, under different target scenarios.

In an embodiment, a first configuration table is shown in FIG. 2, where the target scenario contains an electromagnetic radiation-limited object. In this case, the first configuration table has the power limit for the scenario at 15 dBm, which means that regardless of the antenna operating mode of the target antenna 302, its transmission power must not exceed 15 dBm. As illustrated in FIG. 2, it can be determined that the target power in different antenna operating modes is different. Accordingly, the transmission power in different antenna operating modes is also different, and shall never exceed 15 dBm, which ensures compliance with the protection requirements for electromagnetic radiation-limited objects and prevents the occurrence of excessive radiation.

Moreover, as shown in FIG. 2, the radio frequency front-end module may include a low-noise amplifier 204. The conducted sensitivity shown in FIG. 2, can be understood as the operating parameter of the low-noise amplifier 204. The reception power is a summation of the conducted sensitivity and the reception gain. In reception mode, the reception power is greater than that in the balanced mode and radiation mode. Thus, the reception performance of the antenna can be enhanced in the reception mode, and the antenna can reliably receive the first radiated signal.

In an embodiment of the present disclosure, a second configuration table is shown in FIG. 3, where the target scenario contains a non-limited electromagnetic radiation object. In this case, the target scenario does not include an electromagnetic radiation-limited object. For instance, the electronic device is not close to a human body but placed on a desk. The scenario corresponding to the second configuration table, has no power limit. The target power can be modified to its maximum value, to maximize the radiation performance. In FIG. 3, the up limit of the target power is 23 dBm, which can be used to determine the transmission power in different antenna operating modes.

The parameters in the first and second configuration tables above are merely exemplary, and shall not be specifically limited in the present disclosure. The parameters in the configuration tables can vary based on changes in some attributes of the antenna. In the present disclosure, the values in the tables are solely for illustrative purposes. For instance, the radiation gain measures the ability to transmit signals of the antenna, in a specific direction, while the reception gain measures the ability to receive signals of the antenna in a specific direction. The radiation gain and reception gain are not affected by whether the target scenario contains an electromagnetic radiation-limited object.

As shown in FIG. 4, it illustrates a third configuration table from the prior art, where the target scenario contains an electromagnetic radiation-limited object. In the third configuration table, the target power for all antenna operating modes is the same, which is achieved by reducing the target power of the power amplifier 203 to a same value and then determining the transmission power for different antenna operating modes. More specifically, the transmission power for each antenna operating mode is determined after reducing the target power to 19 dBm. Note that, in reception mode, the transmission power even drops to 10 dBm, which is far below the power limit of 15 dBm. Although this satisfies the protection requirements for electromagnetic radiation-limited objects, the excessively low transmission power causes a degradation in the radiated signal performance. Thus, the base station can be difficult to demodulate the signal. As a result, it negatively affects the throughput rate of the electronic device, and leads to a decrease in throughput of the electronic device, or even causes the device disconnected from the network.

Comparing the first configuration table with the third configuration table, it can be seen that, compared to the prior art, the control method provided in the present disclosure allows for adjusting the target power in the balanced mode to 21 dBm, and the transmission power to 15 dBm, and adjusting the target power in the reception mode up to 23 dBm and in the transmission power to 14 dBm. In contrast, in the prior art, the transmission power in balanced mode is 13 dBm, and in reception mode, it is 10 dBm. The present disclosure achieves improved performance by configuring different target power for different antenna operating modes to transmit the second radiated signal at the second frequency. Thus, the transmission power in different antenna operating modes can be ensured to either equal or approach the power limit of the target scenario, maximizing the radiation performance in each mode. As a result, the electronic device comprising the antenna can maintain stable communication with the base station.

The present disclosure provides an electronic device, which is capable of determining the target operating mode of the target antenna 302 based on the target instructions generated for the current scenario, which allows the target antenna 302 to receive the first radiated signal and transmit the second radiated signal according to the target operating mode. In this case, the target operating modes include multiple different antenna operating modes, and under at least two of the antenna operating modes, the second radiated signal at the second frequency is transmitted at different target power. As a result, the target antenna 302 is able to transmit the second radiated signal based on the current scenario. This solution addresses the issue in the prior art where the power amplifier 203 transmits radiated signals at a same power level, unable to adaptively adjust the target power for transmitting the second radiated signal at the second frequency based on the scenario. This approach improves the radiation performance of the antenna, and ensures stable signal transmission to the base station.

In some embodiments of the present disclosure, as shown in FIG. 6, the electronic device further includes a communication module 201 and a power amplifier 203. The processor 101 is also configured to send a first control instruction to the communication module 201, based on the target power corresponding to the determined target operating mode. The communication module 201 is further configured to control the power amplifier 203 to operate at the corresponding target power based on the first control instruction.

In some embodiments of the present disclosure, the communication module 201 is an electronic device that is capable to modulate digital signals into analog signals for transmission, and also capable to demodulate received analog signals back into digital signals. Its function is to generate analog signals suitable for transmission, and decode them to restore the original digital signals, which enables the communication with the base station in accordance with communication protocols.

In some embodiments of the present disclosure, as shown in FIG. 6, the radio frequency front-end module of the electronic device may also include a transceiver 202 and a duplexer 205, which are connected to the communication module 201. The transceiver 202 includes both a receiver and a transmitter, used for the transmission of electromagnetic signals. The duplexer 205 functions to isolate the transmitted signals from the received signals.

In some embodiments of the present disclosure, the first control instruction sent by the communication module 201 can be received by the transceiver 202, which then controls the operating power of the power amplifier 203 through the transceiver 202.

When the target antenna is determined in the first antenna operating mode, the processor 101 will send a first control instruction to the communication module 201 after determining the target operating mode. Thus, the communication module 201 can send a second control instruction to the transceiver 202 based on the first control instruction. The transceiver 202, controls the power amplifier 203 based on the second control instruction, ensuring that the power amplifier 203 operates at the corresponding target power. The power amplifier 203 is responsible to control the transmission power of every radiated signal. Once the communication module 201 controls the operating power of the power amplifier 203, the corresponding signal is routed through the duplexer 205 and sent to the antenna adjustment module 301, allowing the antenna adjustment module 301 to control the target antenna 302 to radiate signals at the specified transmission power.

Moreover, when the target antenna is determined in the first antenna operating mode, the processor 101 will also send a third control instruction to the antenna adjustment module 301. Thus, the antenna adjustment module 301 can receive the first radiated signal at the first frequency, and simultaneously to transmit the second radiated signal at the second frequency.

In an embodiment, as shown in FIG. 2, when it is determined that the target antenna is in the balanced mode, the processor 101 will determine the target power value to be 21. Based on this, it generates the first control instruction to control the power amplifier 203, via the communication module 201 and transceiver 202, to operate at the target power of 21. Additionally, the processor 101 will determine the radiation gain value of the target antenna to be −6 and the reception gain value to be −8. Based on this, it generates a third control instruction to control the operation of the antenna adjustment module 301, so that the antenna adjustment module 301 can set the target antenna 302 to operate with a radiation gain of −6 and a reception gain of −8.

In some embodiments of the present disclosure, the communication module 201 can adjust the target power of the power amplifier 203 through changing supplied power. By increasing the supplied power to the power amplifier 203, the target power can be increased, and by reducing the supplied power to the power amplifier 203, the target power level can be decreased.

In some embodiments of the present disclosure, the processor 101 is also configured to work for different target scenarios correspond to different target operation modes, and different target scenarios correspond to different power limits.

In embodiments of the present disclosure, by determining the corresponding target operating mode and/or power limit for each scenario, the adaptability between the target scenario and the operating mode and/or power limit can be enhanced. As a result, the transmission power of the antenna can be maximized in each target scenario, thereby improving the radiation performance of the antenna.

In some embodiments of the present disclosure, the target operating modes may include: balanced mode, radiation mode, and reception mode. In scenarios where the target contains an electromagnetic radiation-limited object, the target power in different antenna operating modes is different. Consequently, the transmission power in different antenna operating modes is also different.

In an embodiment, as shown in FIG. 2, in the case where the target scenario contains an electromagnetic radiation-limited object, when the target operating mode is determined to be the balanced mode, the antenna can transmit the second radiated signal at the second frequency with a target power of 21 dBm; when the target operating mode is determined to be the radiation mode, the antenna can transmit the second radiated signal at the second frequency with a target power of 19 dBm; and when the target operating mode is determined to be the reception mode, the antenna can transmit the second radiated signal at the second frequency with a target power of 23 dBm.

In some embodiments of the present disclosure, different power limits can be associated with different electromagnetic radiation-limited objects in different target scenarios. Different power limits can be set for different radiation-limited objects to ensure the protection.

In an embodiment, when the electromagnetic radiation-limited object in the target scenario is a human head, the corresponding power limit can be determined as a first power limit, such as 15 dBm. When the electromagnetic radiation-limited object in the target scenario is a human hand, the corresponding power limit can be determined as a second power limit, which is different from the first power limit.

In some embodiments of the present disclosure, as shown in FIG. 6, the electronic device may include a sensor 102, which is connected with communication to the processor 101. The sensor 102 can detect the scenario where the electronic device is in, to determine the power limit. For example, the electronic device can use sensor 102 to detect its proximity to the human head, thereby determining that the power limit is the first power limit. The processor 101 can then determine the antenna operating mode based on the first configuration table.

In some embodiments of the present disclosure, different configuration tables can be configured for different power limits. For example, the first configuration table shown in FIG. 2 is the configuration table corresponding to the human head, with a power limit of 15 dBm. For other power limits, additional configuration tables can be provided to adjust the target power, which ensures that the transmission power in different antenna operating modes either equals or approaches the power limit of the target scenario.

In some embodiments of the present disclosure, the electronic device further includes a communication module 201. The processor 101 or the communication module 201 is configured to work to obtain the target parameters, when the target antenna 302 is in a first antenna operating mode of the target operating modes. Moreover, the processor 101 is further configured, to switch from the first antenna operating mode to the second antenna operating mode, based on whether the target parameters satisfy the switching condition. In this case, the first antenna operating mode transmits the second radiated signal at the second frequency with the first target power, while the second antenna operating mode transmits the second radiated signal at the second frequency with the second target power, wherein the first target power and the second target power are different.

In this case, when the target parameter satisfies the switching conditions, the antenna operating mode of the target antenna 302 can be switched accurately. Thus, the antenna operating mode of the target antenna 302 can be ensured to match the current scenario, and also the antenna can transmit radiated signal at the target power matching the scenario. As a result, the radiation performance of the antenna can be maximized in different scenarios.

In an embodiment, the first antenna operating mode is the balanced mode, and the second antenna operating mode is the reception mode. When the target parameter satisfies the switching conditions, the target antenna 302 can be switched from the balanced mode to the reception mode. In this case, the target power can be adjusted from 21 dBm to 23 dBm, which improves the transmission power in the reception mode. Compared to the prior art, where the transmission power in reception mode is just 10 dBm, this method increases the transmission power to 14 dBm. Therefore, it improves the radiation performance of the antenna in the reception mode.

In some embodiments of the present disclosure, the target parameters may be related to the real-time scenario where the target antenna 302 is in. These target parameters can change in real time as the scenario changes. Therefore, when the scenario changes, the antenna operating mode of the target antenna 302 can be adjusted in real time by determining the changes in the target parameters. Thus, the target antenna 302 can be ensured to operate in a mode matching the current real-time scenario.

In some embodiments of the present disclosure, as shown in FIG. 6, the electronic device can also include a communication module 201, which is connected to the processor 101 with communication. The target parameters can be obtained by the communication module 201, and then the sent by the communication module 201 to the processor 101, or can be obtained by the processor 101 directly. In the present disclosure, there shall be no specifically limit of the method of acquiring the target parameters, as long as the processor 101 can obtain the target parameters, to facilitate the switching of the antenna operating mode.

In some embodiments of the present disclosure, the target parameters are parameters representing the performance of the target antenna 302 and the radio frequency path of the target antenna 302, which are generated for sending to the base station, in response to request information received from the base station.

In this case, the target parameters can represent the communication status between the base station and the target antenna 302. Based on this communication status between the base station and the target antenna 302, it can be determined whether the antenna operating mode of the target antenna 302 needs to be switched. Thus, the operating mode of the antenna can be adjusted accurately.

In some embodiments of the present disclosure, the target parameter can represent the reception performance and/or the transmission performance of the target antenna 302. The reception performance may include situations where the reception performance of the target antenna 302 is optimal, or situations where the reception performance of the target antenna 302 is degraded. The transmission performance of the target antenna 302 may include situations where the radiated signal transmitted by the target antenna 302 satisfies the requirements of the base station, and can be successfully received by the base station, or situations where the transmitted radiated signal by the target antenna 302 does not satisfies the requirements of the base station, and cannot be successfully received by the base station.

In some embodiments of the present disclosure, the target parameters may include one or more of the following parameters: a signal-to-noise ratio (SNR) of the antenna, or a transmission power margin of the antenna.

In some embodiments of the present disclosure, the processor 101 is further configured to perform at least one of the following steps:
Step one: if a second parameter is less than a second threshold, switching from the first antenna operation mode to the second antenna operation mode, wherein the second parameter being less than the second threshold indicates that the transmission performance of the target antenna does not satisfy the requirements of the base station;
Step two: if a second parameter is less than a second threshold, switching from the first antenna operation mode to the second antenna operation mode, wherein the second parameter being less than the second threshold indicates that the transmission performance of the target antenna does not satisfy the requirements of the base station;
Step three: if the first parameter is less than the first threshold and the second parameter is less than the second threshold, switching from the first antenna operation mode to the second antenna operation mode.

In this case, the antenna operating mode of the target antenna 302 can be determined based on the first parameter and the second parameter of target parameters. Thus, the antenna can be adjusted to the mode most suitable to the current scenario.

In some embodiments of the present disclosure, the first parameter may at least include the signal-to-noise ratio (SNR) of the antenna. When the signal-to-noise ratio is less than the first threshold, it indicates that the ratio of the useful signal strength to the interference signal strength received by the antenna is low. Thus, the target antenna 302 may not be able to receive the first radiated signal at the first frequency effectively. In this case, the target antenna 302 can be switched from the first operating mode to the second operating mode, in order to improve the reception performance. For instance, it can be switching from the balanced mode to the reception mode or from the radiation mode to the reception mode.

In the present disclosure, it shall not be specifically limited about the first antenna operating mode, when the first parameter is less than the first threshold. It can be either the balanced mode or the radiation mode, as long as the second antenna operating mode is the reception mode and able to improve the reception performance.

In some embodiments of the present disclosure, the second parameter may at least include the transmission power margin of the antenna. When the transmission power margin is less than the second threshold, it indicates that the transmission performance of the target antenna 302 does not satisfy the requirements of the base station. In this case, the target antenna 302 may not be able to transmit the second radiated signal at the second frequency effectively. Therefore, the target antenna 302 can be switched from the first operating mode to the second operating mode, in order to improve the radiation performance of the antenna. For instance, it can be switching from the balanced mode to the radiation mode or from the reception mode to the radiation mode. In the case where the reception mode is being switched to the radiation mode, it is necessary to first determine whether the first parameter is less than the first threshold. If so, the antenna shall remain in the reception mode and not switch to the radiation mode. If not, the antenna can be switched from the reception mode to the radiation mode.

In the present disclosure, it shall not be specifically limited about the first antenna operating mode, when the first parameter is greater than or equal to the first threshold and the second parameter is less than the second threshold. It can be either the balanced mode or the reception mode, as long as the second antenna operating mode is the radiation mode, and able improve the radiation performance.

In some embodiments of the present disclosure, when the first parameter is less than the first threshold and the second parameter is less than the second threshold, it indicates that the ratio of the valuable signal strength to interference is low, and the transmission performance of the target antenna 302 does not satisfy the requirements of the base station. In this case, the antenna operating mode of the target antenna 302 can be switched from the first operating mode to the second operating mode, that improves reception performance, which is the reception mode. By using the control method of the present disclosure, the transmission power in reception mode can be increased compared to the prior art, which allows the target antenna 302, even when switched to reception mode, to transmit the second radiated signal at the second frequency with a relatively high transmission power. The issue of further degrading the radiation performance of the antenna can be prevented, after switching to reception mode. The radiation performance of the antenna can be effectively improved to enable the antenna to transmit signals to the base station more reliably.

In an embodiment, as shown in FIG. 2, when it is determined that the target antenna swathes from the balanced mode to the reception mode, the processor 101 will adjust the target power value from 21 to 23. Based on this, it generates a first control instruction to control the power amplifier 203, via the communication module 201 and transceiver 202, to operate at a target power of 23. Additionally, the processor 101 will adjust the radiation gain value of the target antenna from −6 to −9, and the reception gain value from −8 to −6. Based on these adjustments, it generates a third control instruction to control the antenna adjustment module 301, so that the antenna adjustment module 301 can set the target antenna 302 to operate with a radiation gain of −9 and a reception gain of −6.

The present disclosure also provides a computer readable storage medium storing computer instructions. When executed by one or more processors, the computer instructions perform the control method described in the present disclosure.

It should be noted that, according to various embodiments of the present disclosure, each unit can be implemented as computer-executable instructions stored in memory, which, when executed by the processor, can perform the corresponding steps. Alternatively, it can be implemented as hardware with the corresponding logical computation capability or as a combination of software and hardware (firmware). In some embodiments, the processor may be implemented as any of the following: FPGA, ASIC, DSP chip, SoC (System on Chip), MPU (e.g., Cortex), etc. The processor may be communicatively coupled to memory and configured to execute computer-executable instructions stored therein. The memory may include read-only memory (ROM), flash memory, random-access memory (RAM), such as synchronous DRAM (SDRAM) or Rambus DRAM, dynamic random-access memory (DRAM), static memory (e.g., flash, static RAM), etc., where computer-executable instructions are stored in any format. The processor can access these instructions, read them from ROM or any other suitable storage location, load them into RAM, and execute them to implement the wireless communication method of various embodiments of the present disclosure.

It should be noted that, the components of the system in the present disclosure are logically divided according to the functions they are intended to achieve. However, the present disclosure is not limited to such division, and the components can be re-divided or combined as needed. For example, some components can be combined into a single component, or some components can be further divided into more sub-components.

The embodiments of the various components of the present disclosure can be implemented in hardware, software modules running on one or more processors, or a combination of both. Those skilled in the art will understand that microprocessors or digital signal processors (DSPs) can be used to implement some or all of the functions of some or all of the components in the system described in the present disclosure. The present disclosure, can also be implemented as a program (e.g., a computer program or computer program product) for executing part or all of the methods described here. Such an implementation of the program can be stored on a computer-readable medium or take the form of one or more signals. These signals may be downloadable from an Internet site, provided via a carrier signal, or delivered in any other form. Additionally, the present disclosure can be implemented through hardware containing various elements or by a suitably programmed computer. In the claims listing multiple device elements, several elements may be embodied by the same hardware item. The use of terms such as “first,” “second,” and “third” does not imply any order and should be interpreted as labels.

Moreover, although exemplary embodiments have been described herein, the scope of the present disclosure includes any and all embodiments that incorporate equivalent elements, modifications, omissions, combinations (e.g., cross-combinations of various embodiments), adaptations, or changes based on the present disclosure. The elements in the claims should be broadly construed based on the language used in the claims, and should not be limited to the specific examples described in this specification, which should be interpreted as non-limiting.

The above descriptions are intended to be illustrative and not restrictive. For example, the above examples (or one or more configurations thereof) may be combined with one another. A person of ordinary skill in the art may be able to use other embodiments after reading the above descriptions. Additionally, various features have been grouped together in the above detailed description to simplify the description of the present disclosure, which should not be interpreted as an indication that any feature disclosed is essential for any claim. Instead, the claimed subject matter may be less than all of the features of a particular disclosed embodiment. Therefore, the following claims are hereby incorporated into the detailed description as illustrative or exemplary embodiments, where each claim is considered a separate embodiment, and these embodiments can be combined or arranged in various ways with one another. The scope of the present disclosure should be determined by the appended claims and their full range of equivalents.

The above embodiments are only exemplary and are not intended to limit this application. The protection scope of the present disclosure is defined by the claims. Those skilled in the art can make various modifications or equivalent substitutions to the present disclosure within its spirit and protection scope, and such modifications or substitutions should be regarded as falling within the protection scope of the present disclosure.

What is claimed is:

1. A control method, comprising:
determining a target operating mode in response to a target instruction in a target scenario; and
controlling a target antenna in the target operating mode to receive a first radiated signal at a first frequency and transmit a second radiated signal at a second frequency, the first frequency and the second frequency belonging to a same frequency band;
wherein:
the target operating mode includes a plurality of different antenna operating modes;
under at least two of the antenna operating modes of the plurality of different antenna operating modes, the second radiated signal at the second frequency is transmitted at different target powers to cause transmission powers of the plurality of different operating modes to be equal to or approach a power limit of the target scenario; and
the target power represents a power of a radio frequency path between an antenna port of the target antenna and a transceiver.

2. The control method according to claim 1, wherein different target scenarios correspond to different target operating modes, and the different target scenarios correspond to different power limits.

3. The control method according to claim 1, further comprising:
obtaining a target parameter in response to the target antenna being in a first antenna operating mode of the target operating mode; and
switching from the first antenna operating mode to a second antenna operating mode in response to the target parameter satisfying a switching condition;
wherein:
in the first antenna operating mode, the second radiated signal at the second frequency is transmitted with a first target power; and
in the second antenna operating mode, the second radiated signal at the second frequency is transmitted with a second target power, and the first target power and the second target power are different.

4. The control method according to claim 3, wherein the target parameter represents performance of the target antenna and the radio frequency path of the target antenna, is generated in response to request information received from a base station, and is sent to the base station.

5. The control method according to claim 3, wherein switching from the first antenna operating mode to the second antenna operating mode in response to the target parameter satisfying the switching condition includes at least one of:
in response to a first parameter being less than a first threshold, switching from the first antenna operating mode to the second antenna operating mode, the first parameter being less than the first threshold to indicate that reception performance of the target antenna is degraded;
in response to a second parameter being less than a second threshold, switching from the first antenna operating mode to the second antenna operating mode, the second parameter being less than the second threshold to indicate that the transmission performance of the target antenna does not satisfy a requirement of the base station; or
in response to the first parameter being less than the first threshold and the second parameter being less than the second threshold, switching from the first antenna operating mode to the second antenna operating mode.

6. An electronic device, comprising:
a processor configured to determine a target operating mode in response to a target instruction in a target scenario; and
an antenna adjustment module communicatively connected to the processor and configured to control a target antenna in the target operating mode to receive a first radiated signal at a first frequency and transmit a second radiated signal at a second frequency, the first frequency and the second frequency belonging to a same frequency band;
wherein:
the target operating mode includes a plurality of different antenna operating modes;
under at least two of the antenna operating modes of the plurality of different antenna operating modes, the second radiated signal at the second frequency is transmitted at different target powers to cause transmission powers of the plurality of different operating modes to be equal to or approach a power limit of the target scenario; and
the target power represents a power of a radio frequency path between an antenna port of the target antenna and a transceiver.

7. The device according to claim 6, further comprising a communication module and a power amplifier, wherein:
the processor is further configured to send a first control instruction to the communication module based on the target power corresponding to the determined target operating mode; and
the communication module is configured to control the power amplifier to operate at the target power based on the first control instruction.

8. The device according to claim 6, wherein different target operating modes correspond to different target scenarios, and the different target scenarios correspond to different power limits.

9. The device according to claim 6, further comprising a communication module, wherein:
the processor or the communication module is configured to obtain a target parameter in response to the target antenna being in a first antenna operating mode of the target operating mode;
the processor is further configured to switch from the first antenna operating mode to a second antenna operating mode in response to the target parameter satisfying a switching condition;
in the first antenna operating mode, the second radiated signal at the second frequency is transmitted with a first target power; and
in the second antenna operating mode, the second radiated signal at the second frequency is transmitted with a second target power, the first target power and the second target power being different.

10. The device according to claim 9, wherein the processor is further configured to perform at least one of:
in response to a first parameter being less than a first threshold, switching from the first antenna operating mode to the second antenna operating mode, the first parameter being less than the first threshold to indicate that reception performance of the target antenna is degraded;
in response to a second parameter being less than a second threshold, switching from the first antenna operating mode to the second antenna operating mode, the second parameter being less than the second threshold to indicate that the transmission performance of the target antenna does not satisfy a requirement of the base station; or
in response to the first parameter being less than the first threshold and the second parameter being less than the second threshold, switching from the first antenna operating mode to the second antenna operating mode.

11. A computer readable storage medium storing a computer program that, when executed by one or more processors, causes the one or more processors to:
determine a target operating mode in response to a target instruction in a target scenario; and
control a target antenna in the target operating mode to receive a first radiated signal at a first frequency and transmit a second radiated signal at a second frequency, the first frequency and the second frequency belong to a same frequency band;
wherein:
the target operating mode includes a plurality of different antenna operating modes;
under at least two of the antenna operating modes of the plurality of different antenna operating modes, the second radiated signal at the second frequency is transmitted at different target powers to cause transmission powers of the plurality of different operating modes to be equal to or approach a power limit of the target scenario; and
the target power represents a power of a radio frequency path between an antenna port of the target antenna and a transceiver.

12. The storage medium according to claim 11, wherein different target scenarios correspond to different target operating modes, and different target scenarios correspond to different power limits.

13. The storage medium according to claim 11, the one or more processors are further configured to:
obtain a target parameter in response to the target antenna being in a first antenna operating mode of the target operating mode; and
switch from the first antenna operating mode to a second antenna operating mode in response to the target parameter satisfying a switching condition;
wherein:
in the first antenna operating mode, the second radiated signal at the second frequency is transmitted with a first target power; and
in the second antenna operating mode, the second radiated signal at the second frequency is transmitted with a second target power, and the first target power and the second target power are different.

14. The storage medium according to claim 13, wherein the target parameter represents performance of the target antenna and the radio frequency path of the target antenna, is generated in response to request information received from a base station, and is sent to the base station.

15. The storage medium according to claim 13, wherein the one or more processors are further configured to perform at least one of:
in response to a first parameter being less than a first threshold, switching from the first antenna operating mode to the second antenna operating mode, the first parameter being less than the first threshold to indicate that reception performance of the target antenna is degraded;
in response to a second parameter being less than a second threshold, switching from the first antenna operating mode to the second antenna operating mode, the second parameter being less than the second threshold to indicate that the transmission performance of the target antenna does not satisfy a requirement of the base station; or
in response to the first parameter being less than the first threshold and the second parameter being less than the second threshold. switching from the first antenna operating mode to the second antenna operating mode.
